(19) United States
(12) Patent Application Publication
(10) Pub. No.: US 2008/0007214 A1
(43) Pub. Date: Jan. 10, 2008

(54) Carrying case with an emergency charger

(75) Inventor: Chin-Hung Cheng, Chung Ho City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Lucent Trans Electronic Co., Ltd., Chung Ho City (TW)

(21) Appl. No.: 11/483,582

(22) Filed: Jul. 10, 2006

(51) Int. Cl. H02J 7/00

(52) U.S. Cl. 320/114

(57) ABSTRACT

A carrying case with an emergency charger holds and charges electronic devices such as cellular phones and has a holder and a wire. The holder has a main pocket and a charger. The main pocket is defined in the holder and has a top and an opening. The opening is formed at the top of the main pocket and has an edge. The charger is mounted in the main pocket. The wire has an inner end and an outer end. The inner end detachably connects to the charger, and the outer end detachably connects to an electronic device such as a cellular phone. Therefore, the carrying case can charge an electronic device being carried in the carrying case.

### BACKGROUND OF THE INVENTION

1. Field of the Invention

The present invention relates to a bag, and especially a carrying case that holds and charges an electronic device such as a cellular phone, a personal digital assistant or the like.

2. Description of the Related Art

With modern developments in the technology, more and more convenient electronic devices, such as cellular phones, personal digital assistants (PDAs) and the like, are available to virtually everyone today. The electronic devices are so small and lightweight that carrying and operating them is easy. Having and using these electronic devices in modern society is approaching essential. Therefore, more and more people communicate via cellular phones and manage personal and business schedules and files with PDAs, especially when they are away from their office or home or are on the move.

The singular largest problem with most electronic devices is that they operate on rechargeable batteries to provide electricity, and the batteries run down and must be recharged at inconvenient times. When the electronic devices cannot be charged immediately, they cannot work for lack of electricity.

### SUMMARY OF THE INVENTION

The objective of the present invention is to provide a carrying case with an emergency charger to protect and charge an electronic device such as a cellular phone, a personal digital assistant (PDA) or the like.

To achieve the foregoing objective, a carrying case with an emergency charger in accordance with the present invention has a holder and a wire. The holder has a main pocket and a charger. The main pocket is defined in the holder and has a top and an opening. The opening is formed at the top of the main pocket and has an edge. The charger is mounted in the main pocket. The wire has an inner end and an outer end. The inner end detachably connects to the charger, and the outer end detachably connects to an electronic device such as a cellular phone. Therefore, the carrying case can charge an electronic device being carried in the carrying case.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a carrying case with an emergency charger in accordance with the present invention;

FIG. 2 is a front view in partial section of the carrying case in FIG. 1;

FIG. 3 is a perspective view of the carrying case in FIG. 1 with a cellular phone connected to the emergency charger; and

FIG. 4 is a perspective view of the carrying case in FIG. 1 with the cellular phone in the carrying case.

### DETAILED DESCRIPTION OF THE PREFERRED EMBODIMENTS

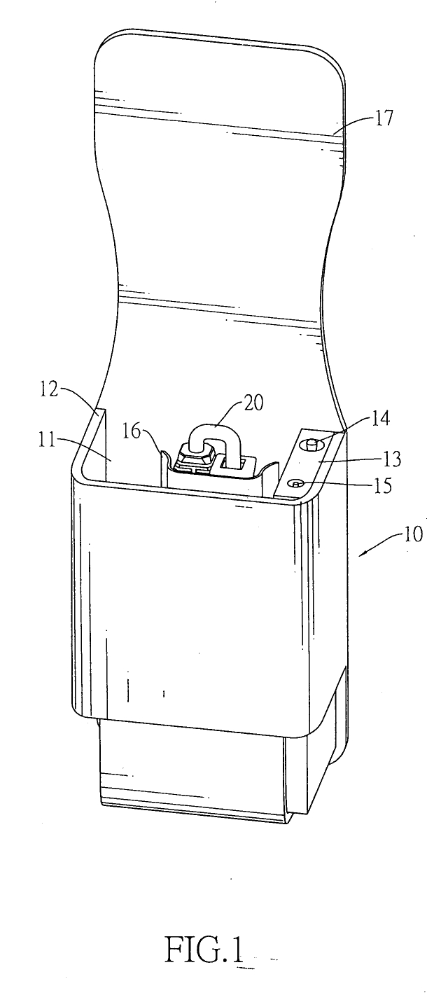

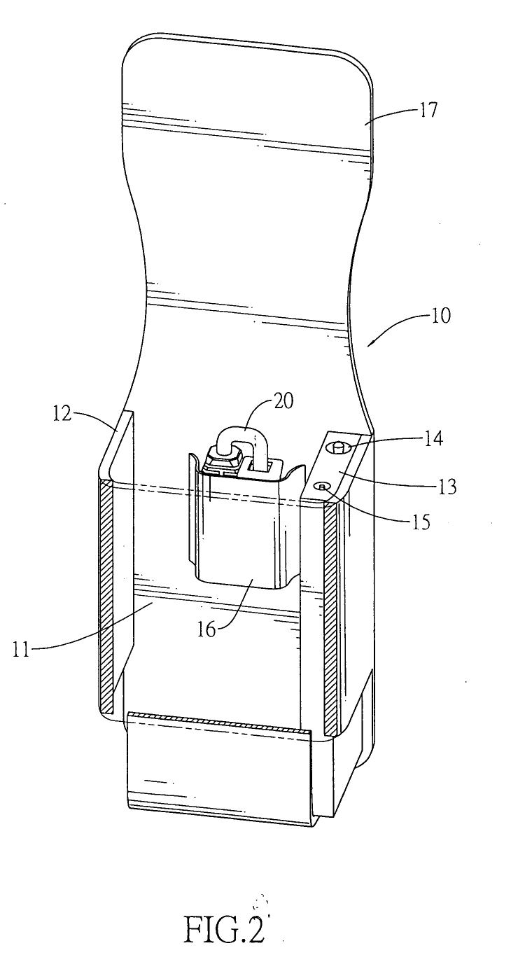

With reference to FIGS. 1 and 2, a carrying case with an emergency charger in accordance with the present invention comprises a holder (10) and a wire (20).

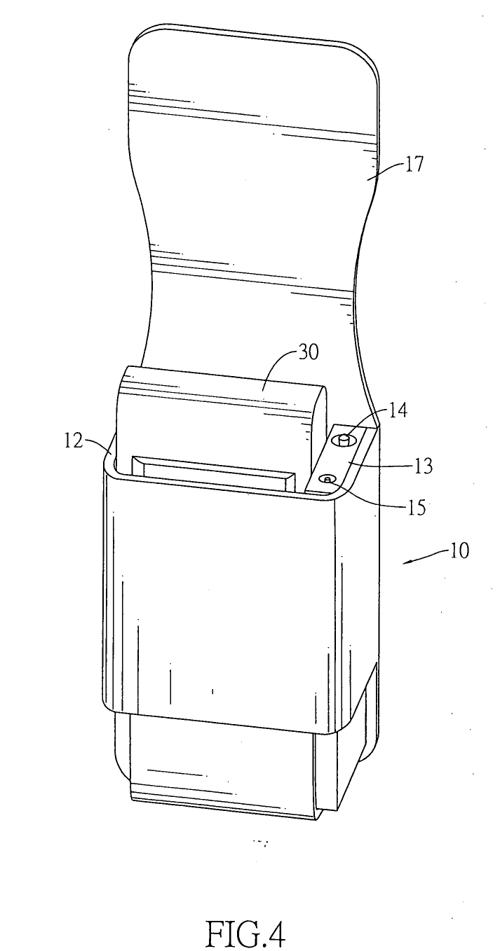

The holder (10) comprises a main pocket (11), a cover (17), a charger (13) and an inner pocket (16). With further reference to FIG. 4, the main pocket (11) is defined in the holder (10) to hold an electronic device such as a cellular phone (30) and has a top, an opening (12) and an internal surface. The opening (12) is formed at the top of the main pocket (11) and has an edge. The cover (17) selectively covers the opening (12), keeps an electronic device in the main pocket (11) from falling out of the holder (10), protects an electronic device in the main pocket (11) from the environment and may be a flap formed on and extending from the edge of the opening (12). The charger (13) is mounted in the main pocket (11), is a rechargeable battery and comprises a top, a male socket (14) and a female socket (15). The male socket (14) is mounted on the top of the charger (13) and outputs electricity to operate or charge an electronic device. The female socket (15) is mounted on the top of the charger (13) and inputs electricity to charge the charger (13). The inner pocket (16) is attached to the internal surface of the main pocket (11) near the opening (12).

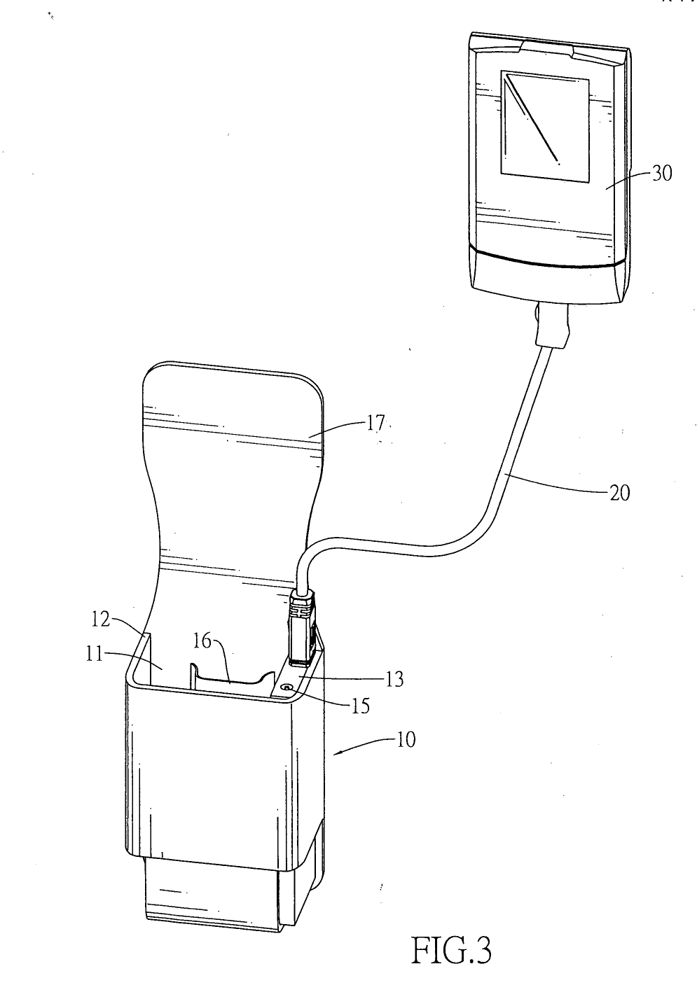

With further reference to FIG. 3, the wire (20) selectively connects the charger (13) to an electronic device, may be stored in the inner pocket (16) and has an inner end and an outer end. The inner end detachably connects to the charger (13) and to the male socket (14) on the charger (13). The outer end detachably connects to an electronic device such as a cellular phone (30).

When a cellular phone (30) indicates low battery voltage, the wire (20) is removed from the inner pocket (16) and connects the cellular phone (30) to the male socket (14) of the charger (13). Therefore, the cellular phone (30) is charged by the charger (13) via the wire (20).

The carrying case (10) as described not only makes carrying an electronic device such as a cellular phone (30), a PDA or the like more convenient but also keeps the electronic device from being scratched or bumped. Furthermore, the carrying case (10) can charge the electronic device.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A carrying case with an emergency charger comprising
a holder comprising
a main pocket being defined in the holder and having
a top;
an opening formed at the top of the main pocket and having an edge; and
an internal surface; and
a charger being mounted in the main pocket, being a rechargeable battery and comprising a top; and
a wire adapted for selectively connecting the charger to an electronic device and having
an inner end detachably connecting to the charger; and
an outer end adapted for detachably connecting to an electronic device.

2. The carrying case as claimed in claim 1, wherein
the charger further comprises
a male socket being mounted on the top of the charger for outputting electricity; and
a female socket being mounted on the top of the charger for inputting electricity; and
the inner end of the wire detachably connect to the male socket on the charger.

3. The carrying case as claimed in claim 2, wherein the holder further comprises an inner pocket attached to the internal surface of the main pocket near the opening.

4. The carrying case as claimed in claim 3, wherein the holder further comprises a cover selectively covering the opening.

5. The carrying case as claimed in claim 4, wherein the cover is a flap formed on and extending from the edge of the opening.
